(19) United States
(12) Patent Application Publication
(10) Pub. No.: US 2015/0167701 A1
(43) Pub. Date: Jun. 18, 2015

(54) TRIGGERED-STROKE ACTUATOR WITH DAMPED RETURN TRAVEL

(71) Applicant: HERAKLES, Le Haillan (FR)

(72) Inventor: Evrard Borg, Pessac (FR)

(73) Assignee: HERAKLES, Le Haillian (FR)

(21) Appl. No.: 14/414,558

(22) PCT Filed: Jul. 12, 2013
(86) PCT No.: PCT/FR2013/051676

§ 371 Date: Jan. 13, 2015

(30) Foreign Application Priority Data
Jul. 13, 2012 (FR) 1256805

(51) Int. Cl. F15B 15/19; B60R 21/38

(52) U.S. Cl. CPC F15B 15/19; B60R 21/38

(57) ABSTRACT

A triggered-stroke actuator presenting at least one additional pyrotechnic charge for adapting its resistance against return to vary in desired manner.

According to the invention, at least one additional pyrotechnic charge (21a-21c) is situated in a housing communicating with the expansion chamber (24) of the actuator (11).

The invention relates to an actuator with triggered stroke that allows the rod of the actuator to perform damped return travel under the effect of a force applied to the rod. More particularly, the invention relates to an improvement to this type of actuator that is remarkable in that the return damping resistance is adapted to the way the force applied to the rod of the actuator varies over time. The invention is particularly adapted to an actuator constituting the drive element of a safety system in a motor vehicle and having the function of rapidly raising the hood of the vehicle in the event of a collision with a pedestrian.

Actuators are known that are designed for raising a motor vehicle hood. Such an actuator is triggered by a pyrotechnic charge when a collision is imminent, so as to avoid a pedestrian, and in particular the pedestrian's head, striking the engine block after deformation of the hood. The hood is raised from its rear end, in the vicinity of the windshield. The hood remains attached to the front of the motor vehicle. The actuator is arranged so that, after the hood has been raised, it is possible for the hood to be returned in damped manner in order to accompany the force acting on the hood and reduce the impact on the pedestrian. The return damper system is advantageously combined with the actuator that raised the hood. The assembly is constituted by the hood, the raising mechanism, and the piston of the actuator that retracts under the impact (after the hood has initially been raised and deformed under the impact) while being braked and then blocked. The damper device is arranged in the cylinder of the actuator. It makes use of mechanical means, as described for example in patent FR 2 878 212. Under such circumstances, the mechanical means hold the hood in the deployed position until the impact against the pedestrian, and then retract under the effect of the force from the impact, while absorbing energy.

According to another possibility, a damping effect against return is obtained by maintaining the pressurization chamber of the actuator under a pressure that is sufficiently high to oppose its return movement. The use of a pyrotechnic charge of large weight serving both to pressurize the piston in order to deploy the actuator quickly and then to maintain the piston chamber under pressure presents drawbacks. A pyrotechnic charge of that type would imply the actuator deploying too suddenly, running the risk of damaging the deployment mechanism and the hood. Patent FR 2 938 884 proposes using an additional pyrotechnic charge of combustion that is slower than that of the charge used for giving rise to the initial rapid deployment. That slow additional pyrotechnic charge is incorporated in the actuator and is advantageously fired by the rapid combustion charge already present in the gas generator of the actuator. It may be housed either in the gas generator itself, or else in a location that is in communication with the pressurization chamber of the actuator, e.g. in a cavity of the piston, which cavity opens out into the combustion chamber of the actuator. After the hood has been deployed, the slow combustion additional charge takes over from the charge that caused the hood to be raised rapidly and that is no longer supplying sufficient gas. Combustion of the slow charge maintains a level of pressure in the expansion chamber of the actuator that is of sufficient magnitude and that lasts for a sufficiently long time to enable the hood to be returned in damped manner during the impact. The variation in the pressure that is observed in the pressurization chamber of that type of actuator then presents a rapid rise generated by the rapid combustion pyrotechnic charge in order to deliver the energy needed for deploying the system in a very short period of time, typically shorter than 30 milliseconds (ms) in a pedestrian-protection application. Thereafter, a lower pressure becomes established in the chamber, at a level that depends on the combustion of the slow charge and for a duration of the order of 300 ms for the pedestrian-protection application. The durations of 30 ms and of 300 ms may be modified and adapted depending on the application.

As a general rule, in the event of a collision with a pedestrian, it is found that the pedestrian is tipped over and rolls progressively upwards onto the hood at the front of the vehicle. The pedestrian is then subjected to at least three violent impacts that are spaced apart by a few tens of milliseconds, the first corresponding to an impact against the hip, the second corresponding to an impact against the chest, and the third corresponding to an impact against the head. It is thus desirable, for better protection of the pedestrian, to propose an actuator of triggered stroke that makes it possible, after deployment of the hood, to generate damping resistance that is at least generally adapted to those three successive impacts against the hip, the chest, and the head of the pedestrian. Specifically, those portions of the body have different masses, and ideally they require different damping forces.

For this purpose, the invention provides a triggered-stroke actuator comprising a body housing a piston connected to a rod that projects from one end of said body, said rod being adapted to be coupled to a mechanism able to exert thereon a variable return force, and a controlled gas generator mounted in said body facing said piston and at a predetermined distance from an initial position prior to being triggered, an expansion chamber thus being defined between said gas generator and said piston, said gas generator including an initial activation pyrotechnic charge of the actuator that is in communication with said expansion chamber, the actuator being characterized in that it further includes at least one additional pyrotechnic charge, situated in a housing in communication with said expansion chamber in order to exert resistance against return on the piston, which resistance is adapted to the way said variable return force acting on said rod varies over time.

In the embodiments described below, the way in which the return damping resistance varies over time is adapted to an impact or to a series of successive impacts, possibly occurring a certain length of time after an imminent collision has been detected and/or in response to a series of impacts.

The force exerted in return on the rod may be consecutive to the actuator being deployed; it may optionally begin after a certain length of time.

It can be understood that the return damping resistance is associated with the way in which the pressure in the expansion chamber varies during the impact or the succession of impacts.

Advantageously, the additional pyrotechnic charge presents combustion duration that is longer than that of the initial activation pyrotechnic charge.

This additional pyrotechnic charge may be housed in the body of the actuator in communication with the expansion chamber.

In an example, the additional pyrotechnic charge is housed in a cavity of the piston, which cavity opens out into the expansion chamber facing the controlled gas generator.

In this manner, the additional pyrotechnic charge may be ignited automatically, after a certain delay that can be controlled by construction, by using the initial activation pyrotechnic charge.

In an example, the expansion chamber with which the gas generator communicates is situated on the end of the piston opposite from the rod.

In an example, the additional pyrotechnic charge presents a shape and/or a composition adapted so that its combustion generates a flow of gas, in the expansion chamber at a rate that varies over time, and that increases, at least over a given period of time.

Advantageously, the pyrotechnic charge may be arranged in such a manner that its area for combustion varies during its combustion, and in particular in such a manner that this combustion area increases during at least one stage of combustion.

For example, the additional pyrotechnic charge may present a section that varies, and in particular a section that increases over at least a portion of its length taken generally along an axis extending from the end of the charge situated in the vicinity of the gas expansion chamber and going towards its opposite end. By way of example, this axis may coincide with or be substantially parallel with the axis of the rod.

The additional pyrotechnic charge may thus have a flared shape, in particular a frustoconical or pyramid (or similar) shape, with its smaller section end being situated in the vicinity of said expansion chamber, and in particular its axis may coincide with or be substantially parallel with the axis of the rod.

In another variant, the additional pyrotechnic charge is constituted by a plurality of combustible blocks of different characteristics in alignment along the direction of said rod.

In particular, the additional pyrotechnic charge may comprise a plurality of combustible blocks having different characteristics that are coupled to one another, in other words that are arranged in such a manner that each block is initiated following the directly adjacent block. The pyrotechnic blocks constituting the additional pyrotechnic charge are preferably in contact with one another in order to form a one-piece unit.

These combustible blocks may have sections and/or lengths that differ along said axis. They may also be constituted by materials that present different speeds of combustion.

Advantageously, the additional pyrotechnic charge has a portion of its surface covered by a protective coating against combustion (also referred to as a combustion-inhibitor coating) in order to favour one direction of propagation for the combustion front over time. In other words, the additional pyrotechnic charge is ignited from one end and combustion propagates in practically rectilinear manner along an axis, which axis coincides with the axis of the rod of the actuator.

By acting on these various parameters, it is possible to define how the flow rate of gas generated by said additional pyrotechnic charge varies over time so as to make the flow rate correspond to a return force exerted on said rod that matches a curve corresponding approximately to that which is needed for providing good damping of the above-defined impact(s), in particular the three probable impacts against the hip, the chest, and the head of the pedestrian.

In another possible embodiment, the actuator includes or is associated with a secondary expansion chamber communicating with the first-mentioned expansion chamber and housing a plurality of additional pyrotechnic charges connected to respective actuator means.

For example, these actuator means comprise igniters respectively coupled to said additional pyrotechnic charges, and these igniters are connected to firing means arranged to control said charges in a predetermined order.

The magnitudes and the durations of the combustion of the additional pyrotechnic charges may be predetermined as a function of the above-mentioned impacts that are to be expected.

For example, the firing means may be controlled by a sensor for sensing movement of the rod of the actuator. During the return movement of the rod, the sensor controls the firing means (microprocessor), which means trigger the additional pyrotechnic charges in succession in order to raise the level of pressure in the expansion chamber.

The compounds making up the initial activation pyrotechnic charge and the additional pyrotechnic charge(s) may be selected from those generally used for gas generators in the field of motor vehicle safety for use in airbags, safety pre-tensioners, extinguishers, and hood-raising actuators.

For example, the compounds described in patent applications WO 2006/134311 and WO 2007/042735, and in particular those that are constituted essentially by guanidine nitrate and basic copper nitrate, are well adapted for the invention. The person skilled in the art can easily adjust the combustion speeds of these compounds and can dimension the pyrotechnic charges so as to obtain pressurization sequences for said expansion chamber in a manner that is desirable for providing good damping of the impacts that result from colliding with a pedestrian.

The compounds described in patent application WO 2009/095578, e.g. essentially comprising azidocrabonamide and a nitrogen-containing reducing charge can be used as ingredients for said additional pyrotechnic charge, with the heat needed to make them decompose then being provided by said initial activation pyrotechnic charge.

The invention can be better understood and other advantages thereof appear more clearly in the light of the following description of several possible embodiments of an actuator specifically having a triggered stroke, the description being given purely by way of example and being made with reference to the accompanying drawings, in which:

FIG. 1 is a diagram showing a triggered-stroke actuator in a first embodiment of the invention;

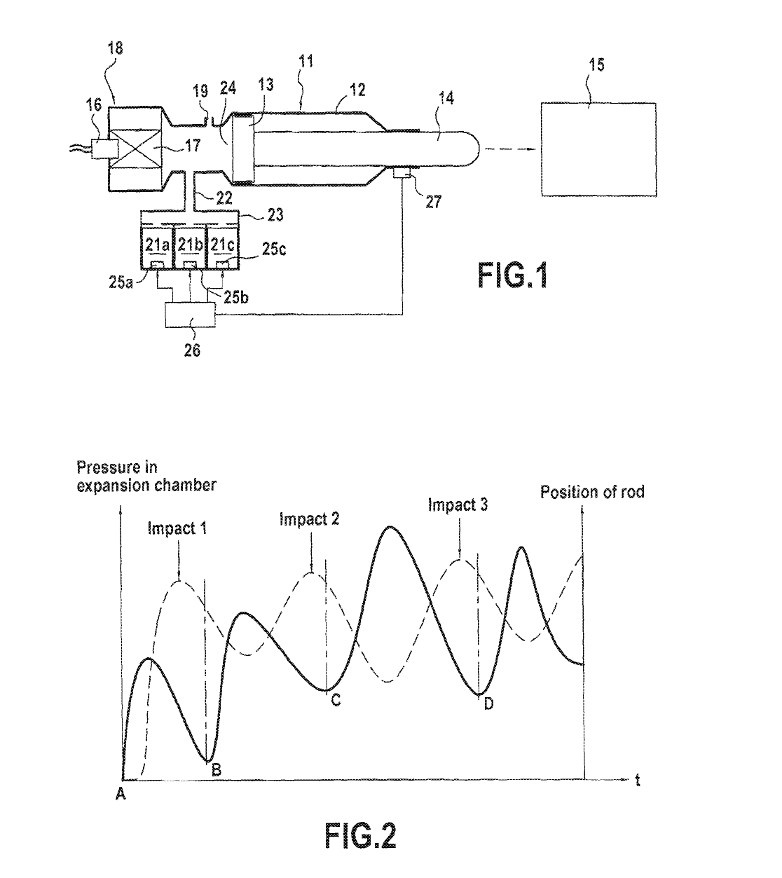

FIG. 2 is a graph showing the behavior of the actuator during the return damping period that follows triggering of the actuator; and

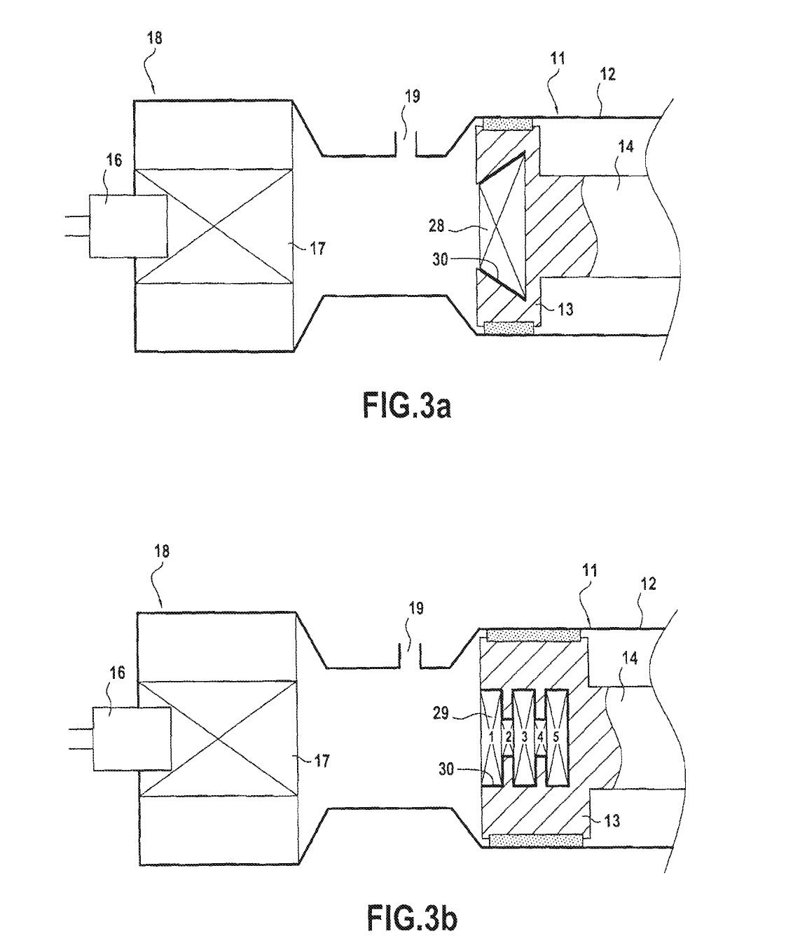

FIGS. 3a and 3b are fragmentary views of two variants of the invention.

In FIG. 1, there can be seen a triggered-stroke/actuator 11 comprising a generally cylindrical body 12 housing a piston 13 connected to a rod 14 that projects from a first end of the body. The rod 14 is adapted to be coupled to a mechanism 15 able to exert thereon a return force of variable magnitude. Typically, it is a hood-raising mechanism for the purpose of protecting a pedestrian during a collision, in known manner.

At its other end, the actuator has a controlled gas generator 18. It is constituted by an initial activation pyrotechnic charge 17 with rapid combustion, and a firing device 16 associated with the charge and controlled electrically. The arrangement is such that an expansion chamber 24 is defined between the gas generator 18 and the piston 13. In this example, the initial activation pyrotechnic charge 17 of the actuator is axially in line with and behind the rod 14.

In the example shown, an orifice 19 is formed through the wall of this expansion chamber 24 in order to create a leakage flow of gas to the outside of the chamber. In this manner, the pressure that is generated in the expansion chamber tends to decrease after the hood has been raised, i.e. after a certain length of time has elapsed since firing and combustion of the initial activation pyrotechnic charge 17. A pyrotechnic gas leak may be arranged between the piston and the body of the actuator in the manner described in FR 2 961 274, in particular.

According to an important characteristic of the invention, the actuator includes or is associated with at least one additional pyrotechnic charge 21a, 21b, 21c, e.g. with delayed actuation, situated in a housing 23 in communication with the expansion chamber in order to act on the piston to exert resistance (pressure) against its return, which resistance is adapted to the way the variable return force acting on the rod of the actuator 14 varies over time.

Very generally, the additional pyrotechnic charge presents combustion duration that is longer than that of said initial activation pyrotechnic charge 17.

In the example of FIG. 1, the housing 23 forms a secondary expansion chamber in communication with the expansion chamber 24 via a duct 22. This secondary expansion chamber houses a plurality of additional pyrotechnic charges 21a, 21b, 21c connected to respective controlled actuator means.

In the example, these actuator means comprise igniters 25a, 25b, 25c respectively coupled to said additional pyrotechnic charges, and these igniters are connected to firing means 26, 27 arranged to cause said charges to ignite in a predetermined order. For example, the actuator means comprise a control circuit 26 including a microprocessor or the like and generating electric signals that are applied to the igniters in a predetermined order. In this example, the control circuit is itself controlled by a sensor 27 detecting movement of the rod 14.

The operation of the actuator of the invention is explained with reference to the graph of FIG. 2. In the graph, time is plotted along the abscissa axis, the bold-line curve illustrates how pressure in the expansion chamber 24 varies over time, and the dashed-line curve illustrates how the position of the rod 14 of the actuator varies over time. The dashed-line curve thus represents the return force that acts on the rod after the actuator has been triggered.

In the event of an imminent impact being detected, (e.g. detected by radar or the like), the gas generator 18 is triggered and the initial activation pyrotechnic charge is fired at instant A. The pressure inside the expansion chamber 24 increases very rapidly, thereby causing the hood to be raised. Thereafter, because of the calibrated leak 19 and/or because of the combustion of the charge coming to an end, and/or because of the cooling of the pyrotechnic gas, pressure begins to decrease. If the impact is avoided in extremis, the additional pyrotechnic charges 21a-21c are not fired and the hood, which is still intact, can be put back into position.

If a collision occurs, a first impact (impact 1) causes the rod 14 to retract into the inside of the body of the actuator and this movement is detected by the sensor 27, which sensor then causes a first additional pyrotechnic charge 21a to be fired thereby refilling the expansion chamber 24. The firing of this first additional charge takes place at point B. This causes a rise in pressure, which leads to an increase in the resistance of the rod to returning, followed by a new decrease of the pressure inside the expansion chamber. When a second impact occurs (impact 2), the sensor causes the second additional pyrotechnic charge 21b to be fired, with this taking place at point C. The pressure in the expansion chamber increases once more, and then decreases. When the third impact occurs, new movement of the rod 14 towards the inside of the actuator gives rise, at D, to the third additional pyrotechnic charge 21c being fired. It can thus be seen that a certain amount of pressure is maintained in the expansion chamber 24 to oppose the rod 14 returning too rapidly into the inside of the actuator, thus making it possible to damp the return of the hood, and to do so with a certain amount of resistance that avoids the pedestrian impacting against the engine block, with deformation of the hood absorbing a large portion of the energy.

FIGS. 3a and 3b describe variants in which said at least one additional pyrotechnic charge is ignited directly by the initial activation pyrotechnic charge 17 of the actuator. It is thus the shape and/or the constitution of the additional pyrotechnic charge that determines the return damping that it exerts on the rod.

The general arrangement of the actuator described with reference to FIG. 1 remains identical to that described above. In FIGS. 3a and 3b, structural elements that are analogous to those of FIG. 1 are thus given the same numerical references and they are not described again.

In these examples, the at least one additional pyrotechnic charge 28 or 29 is housed in the body of the actuator in communication with the expansion chamber itself. More particularly, in both of these examples, the additional pyrotechnic charge is housed in a cavity of the piston 13, which cavity opens out into the expansion chamber facing the controlled gas generator 18.

A portion of its surface is covered by a protective coating 30 in order to favour one particular direction for propagation of the combustion front over time. By way of example, this coating is a varnish. In the example of FIG. 3a, the additional pyrotechnic charge 28 is frustoconical in shape on the same axis as the rod. The smaller-section end of the charge is situated in the vicinity of the expansion chamber. The additional pyrotechnic charge is thus ignited a certain length of time after the initial activation pyrotechnic charge 17 of the actuator is ignited, specifically by the flame that it gives off. In the example of FIG. 3a, the protective coating extends over the frustoconical surface of the charge. The shape of the additional pyrotechnic charge is such that the quantity of gas given off increases over time because of the ever increasing area of combustion, given that the combustion propagates in a direction that is substantially longitudinal, parallel to the axis of the rod 14.

In the example of FIG. 3b, the additional pyrotechnic charge 29 is constituted by a plurality of combustible blocks having different characteristics and arranged side-by-side in alignment on the longitudinal direction of the rod 14. Thus, in the example, there can be seen five blocks: two blocks of small size (2, 4) being arranged between three blocks of larger size (1, 3, 5). It can thus be understood that under such conditions, the curve for pressure inside the expansion chamber is similar to that shown in FIG. 2. As in the preceding example, the surface of the set of these blocks, not including the surface of the first block adjacent to the expansion chamber, is covered in a protective coating 30 that favours propagation of combustion in a direction that is axial. Naturally, the adjacent combustible blocks could be constituted by materials that present different speeds of combustion.

In a variant, the combustible blocks could be arranged so as to favour combustion in a direction that is radial at a speed of combustion that varies in concentric layers.

1. A triggered-stroke actuator comprising a body housing a piston connected to a rod that projects from one end of said body, said rod being adapted to be coupled to a mechanism able to exert thereon a variable return force, and a controlled gas generator mounted in said body facing said piston and at a predetermined distance from an initial position prior to being triggered, an expansion chamber thus being defined between said gas generator and said piston, said gas generator including an initial activation pyrotechnic charge of the actuator that is in communication with said expansion chamber, wherein the actuator further includes at least one additional pyrotechnic charge, situated in a housing in communication with the expansion chamber in order to exert resistance against return on the piston, which resistance is adapted to the way said variable return force acting on said rod varies over time.

2. An actuator according to claim 1, wherein said additional pyrotechnic charge presents a shape and/or a composition adapted so that its combustion generates a flow of gas in the expansion chamber at a rate that varies over time, and that increases, at least over a given period of time.

3. An actuator according to claim 1, wherein the additional pyrotechnic charge presents a varying section.

4. An actuator according to claim 1, wherein said additional pyrotechnic charge has a flared shape, in particular a frustoconical or pyramid shape, with its smaller section end being situated in the vicinity of said expansion chamber, and in particular has a shape of axis that coincides with or is substantially parallel with the axis of the rod.

5. An actuator according to claim 1, wherein said additional pyrotechnic charge has a frustoconical shape of axis that coincides with the axis of said rod, and with its smaller section end being situated in the vicinity of said expansion chamber.

6. An actuator according to claim 1, wherein said additional pyrotechnic charge comprises a plurality of combustible blocks of different characteristics coupled to one another, in particular being in alignment along the direction of the rod.

7. An actuator according to claim 6, wherein said combustible block are of different sections and/or lengths.

8. An actuator according to claim 6, wherein said combustible blocks are constituted by materials that present different speeds of combustion.

9. An actuator according to claim 1, wherein said at least one additional pyrotechnic charge is housed in the body of the actuator in communication with said expansion chamber.

10. An actuator according to claim 1, wherein said at least one additional pyrotechnic charge is housed in a cavity of the piston, which cavity opens out into the expansion chamber facing said controlled gas generator.

11. An actuator according to claim 1, wherein said at least one additional pyrotechnic charge has a portion of its surface covered by a protective coating in order to favour one direction of propagation for the combustion front over time.

12. An actuator according to claim 1, including a secondary expansion chamber communicating with the first-mentioned expansion chamber and housing a plurality of additional pyrotechnic charges connected to respective actuator means.

13. An actuator according to claim 12, wherein said actuator means comprise igniters respectively coupled to said additional pyrotechnic charges, and these igniters are connected to firing means arranged to control said charges in a predetermined order.

14. An actuator according to claim 13, wherein said firing means are controlled by a sensor for sensing movement of said rod.

15. An actuator according to claim 1, wherein an orifice is formed through the wall of said expansion chamber in order to create a leakage flow of gas to the outside of the chamber.

16. An actuator according to claim 1, wherein said additional pyrotechnic charge presents combustion duration that is longer than that of said initial activation pyrotechnic charge.

17. An actuator according to claim 1, wherein the initial activation pyrotechnic charge and the additional pyrotechnic charge are essentially constituted by guanidine nitrate and basic copper nitrate.

18. An actuator according to claim 1, wherein the initial activation pyrotechnic charge and the additional pyrotechnic charge are essentially constituted by azodicarbonamide and by a nitrogen-containing reducing charge.

19. An actuator according to claim 1, wherein the expansion chamber with which the gas generator communicates is situated on the end of the piston opposite from the rod.
